(19) United States
(12) Patent Application Publication
(10) Pub. No.: US 2025/0008582 A1
(43) Pub. Date: Jan. 2, 2025

(54) LOCATING REMOTE USER EQUIPMENT (UE) OUT OF CELLULAR COVERAGE

(71) Applicant: Telefonaktiebolaget LM Ericsson (publ), Stockholm (SE)

(72) Inventors: Ritesh SHREEVASTAV, Upplands Väsby (SE); Åke BUSIN, Sollentuna (SE); Antonino ORSINO, Kirkkonummi (FI)

(21) Appl. No.: 18/696,056

(22) PCT Filed: Sep. 20, 2022
(86) PCT No.: PCT/SE2022/050823

§ 371 Date: Mar. 27, 2024

Related U.S. Application Data
(60) Provisional application No. 63/248,624, filed on Sep. 27, 2021.

(51) Int. Cl. H04W 76/14; H04W 64/00

(52) U.S. Cl. CPC H04W 76/14; H04W 64/00

(57) ABSTRACT

Embodiments include methods for a positioning node associated with a radio access network (RAN). Such methods include receiving, from a core network node (CNN) associated with the RAN, a request for a position of a target UE that is present but out-of-coverage with respect to the RAN. The request includes an identifier of a reference UE for communication between the target UE and the RAN. Such methods include obtaining from the reference UE positioning measurements performed on a sidelink between the reference UE and the target UE, and determining the position of the target UE based on the obtained positioning measurements. Such methods include sending the position of the target UE to the CNN, in accordance with the request. Other embodiments include complementary methods for a CNN, as well as CNNs and positioning nodes configured to perform such methods.

### TECHNICAL FIELD

The present disclosure generally relates to wireless communication networks, and more specifically to determining the geographic location of a target user equipment (UE) that is out-of-coverage with respect to a radio access network (RAN) but reachable via a reference UE using sidelink connection.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency 20) division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Sidelink (SL) is a type of device-to-device (D2D) communication whereby UEs can communicate with each other directly rather than indirectly via a 3GPP RAN. The first 3GPP standardization of SL was in LTE Rel-12 targeting national security and public safety (NSPS) use cases. Since then, a number of enhancements have been introduced to broaden the use cases that could benefit from D2D technology. For example, the D2D extensions in LTE Rel-14 and Rel-15 include supporting vehicle-to-everything (V2X) communication.

While LTE V2X was primarily directed at traffic safety services, V2X use cases for 5G (also referred to as “New Radio” or “NR”) also include applications not entirely safety-related, such as sensor/data sharing between vehicles to enhance knowledge of the surrounding vehicular environment. As such, NR SL is envisioned to support applications such as vehicles platooning, cooperative maneuver between vehicles, remote/autonomous driving, etc.

3GPP standards provide various ways for positioning (e.g., determining the position of, locating, and/or determining the location of) UEs operating in NR networks. In general, a positioning node configures a target device (e.g., UE) and/or RAN nodes (e.g., gNB, ng-eNB, etc.) to perform one or more positioning measurements according to one or more positioning methods. For example, the positioning measurements can include timing (and/or timing difference) measurements on UE, network, and/or satellite transmissions. The positioning measurements are used by the target device, the measuring node, and/or the positioning node to determine the target device's location.

NSPS positioning scenarios and/or use cases are expected to be important for 3GPP Rel-17. Certain NR SL features that were specified in 3GPP Rel-16 are likely to be the baseline for enhancements to NSPS positioning use cases. NSPS services may need to operate without (or with partial) RAN coverage, such as during indoor firefighting, forest firefighting, earthquake rescue, sea rescue, etc. In these scenarios, coverage extension is a crucial enabler for NSPS. 3GPP Rel-17 includes a study item for coverage extension for SL-based communication, including UE-to-network relay for cellular coverage extension and UE-to-UE relay for SL coverage extension.

### SUMMARY

Accordingly, SL-based positioning is expected to be important for NSPS scenarios and/or use cases in which UEs are (at least partially) out of network coverage. However, there are various problems, issues, and/or difficulties that prevent SL-based positioning from meeting requirements of these NSPS scenarios and/or use cases.

Embodiments of the present disclosure provide specific improvements to positioning of UEs operating (at least partially) out of network coverage, such as by providing, enabling, and/or facilitating solutions to overcome exemplary problems summarized above and described in more detail below.

Some embodiments include methods (e.g., procedures) for a positioning node associated with a radio access network (RAN).

These exemplary methods can include receiving, from a core network node (CNN) associated with the RAN, a request for a position of a target UE that is present but out-of-coverage with respect to the RAN. The request includes an identifier of a reference UE for communication between the target UE and the RAN. These exemplary methods can also include obtaining, from the reference UE, positioning measurements performed on a sidelink between the reference UE and the target UE. These exemplary methods can also include determining the position of the target UE based on the obtained positioning measurements and sending the position of the target UE to the CNN, in accordance with the request.

In some embodiments, the positioning node is an LMF and the CNN is an AMF.

In some embodiments, the obtained positioning measurements include first positioning measurements performed by the target UE and second positioning measurements performed by the reference UE. In some of these embodiments, the first positioning measurements performed by the target UE include timing measurements and/or power measurements (including power measurements per path if multiple paths exist) on signals transmitted by the reference UE.

In some of these embodiments, the second positioning measurements made by the reference UE can include any of the following:
timing measurements made by the reference UE on signals transmitted by the target UE;
power measurements made by the reference UE on signals transmitted by the target UE;
timing measurements made by the reference UE on signals transmitted by a RAN node;
power measurements made by the reference UE on signals transmitted by a RAN node; and
time-difference measurements made by the reference UE on signals transmitted by a plurality of RAN nodes.

In some embodiments, these exemplary methods can also include receiving from the CNN a further request for a reference UE for communication between the target UE and the RAN and obtaining further positioning measurements associated with a plurality of candidate reference UEs. In some of these embodiments, the further positioning measurements associated with each candidate reference UE includes one or more of the following:
one or more of the following measurements made by the candidate reference UE on signals transmitted by a RAN node: received power, and timing;
one or more of the following measurements made by the RAN node on signals transmitted by the candidate reference UE: received power, and timing; and
a degree of stationarity of the candidate reference UE; and
energy conditions associated with the candidate reference UE.

In some of these embodiments, these exemplary methods can also include the following: selecting a first one of the candidate reference UEs as the reference UE for the target UE, based on the further positioning measurements; and sending to the CNN an identifier of the selected first candidate reference UE, in accordance with the further request.

In some variants, the first candidate reference UE can be selected as the reference UE for the target UE based on one or more of the following:
line-of-sight to the RAN node, as indicated by the received power measurements;
closest to the RAN node, as indicated by the timing measurements;
most stationary of the candidate reference UEs; and
powered by mains or highest remaining stored energy of the candidate reference UEs.

In some of these embodiments, the identifier of the selected first candidate reference UE sent to the CNN is the identifier of a reference UE that is received from the CNN in the request for a position of the target UE.

Other embodiments include methods (e.g., procedures) for a CNN configured to support positioning of UEs in a RAN.

These exemplary methods can include receiving, from a first positioning node, a first request for positioning of a target UE. These exemplary methods can also include determining that the target UE is present but out-of-coverage with respect to the RAN and sending, to a second positioning node, a request to position the target UE. The request can include an identifier of a reference UE for communication between the target UE and the RAN. These exemplary methods can also include receiving the position of the target UE from the second positioning node, in accordance with the second request, and sending the position of the target UE to the first positioning node, in accordance with the first request.

In some embodiments, the CNN is associated with a database that includes a plurality of records associated with a respective plurality of UEs, with each record including a last known location for a particular UE and a last known reference UE for the particular UE. In some of these embodiments, determining that the target UE is present but out-of-coverage with respect to the RAN is based on a previous authentication by the target UE or a previous registration by the target UE. Additionally, the previous authentication or the previous registration was performed by the CNN directly with the target UE, or indirectly with the target UE via the reference UE.

In some of these embodiments, these exemplary methods can also include storing the position of the target UE in the database record associated with the target UE.

In some embodiments, these exemplary methods can also include determining the reference UE for communicating between the target UE and the RAN. Different variants of these embodiments are possible.

In some of these embodiments, determining the reference UE for communication between the target UE and the RAN includes the following:
sending a page for the target UE to a last known reference UE for the target UE;
receiving, from the last known reference UE, a response indicating whether the target UE responded to the page; and
selecting the last known reference UE as the reference UE based on the response indicating that the target UE responded to the page.

In some of these embodiments, determining the reference UE for communication between the target UE and the RAN includes the following:
sending, to the second positioning node, a third request to identify a reference UE for communication between a target UE and the RAN; and
receiving, from the second positioning node, a third response including an identifier of a candidate reference UE selected by the second positioning node.

In some of these embodiments, the first positioning node is a GMLC, the second positioning node is an LMF, and CNN is an AMF. In some of these embodiments, the identifier candidate reference UE that is received from the second positioning node is the identifier of a reference UE that is sent to the second positioning node in the second request.

In some of these embodiments, sending the request to identify a reference UE to the second positioning node is based on one or more of the following:
a database record associated with the target UE does not include a last known reference UE; and
an indication that the target UE did not respond to a page via the last known reference UE.

In some embodiments, these exemplary methods can also include, in response to the first request, paging the target UE via the reference UE to determine a time required to position the target UE and sending to the positioning node an indication of the time required to position the target UE. In some of these embodiments, paging the target UE via the reference UE includes the following operations:
sending to the RAN a paging message that includes an identifier of the target UE and a paging reason associated with locating the target UE; and
receiving from the RAN from the RAN a paging response indicating when the target UE responded to a page from the RAN via the reference UE.

Other embodiments include positioning nodes (e.g., LMFs, E-SMLCs, SUPLs, etc.) and CNNs (e.g., AMFs, MMEs, etc.) configured to perform operations corresponding to any of the exemplary methods described herein. Other embodiments include non-transitory, computer-readable media storing program instructions that, when executed by processing circuitry, configure such positioning nodes and CNNs to perform operations corresponding to any of the exemplary methods described herein.

These and other embodiments described herein can facilitate network support for positioning of a target UE operating out of RAN coverage with only a SL connection to another UE. Additionally, embodiments can provide early indication to requesting applications that there may be delay in fulfilling a location request for an out-of-coverage target UE, thereby enabling requesting applications to take appropriate action in a timely manner. Embodiments can enable identification for positioning purposes of reference (or relay) UE(s) for an out-of-coverage target UE, thereby facilitating positioning of the out-of-coverage target UE in accordance with a request.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 illustrates a high-level views of an exemplary 5G/NR network architecture.

FIG. 2 shows an exemplary configuration of NR user plane (UP) and control plane (CP) protocol stacks.

FIG. 3 is a block diagram illustrating a high-level architecture for supporting UE positioning in NR networks.

FIG. 4 shows an exemplary arrangement of interfaces between two V2X UEs and a RAN.

FIG. 5 shows three exemplary network coverage scenarios for two UEs and a gNB serving a cell.

FIGS. 6-7 illustrate exemplary SL UP and CP protocol stacks, respectively, including a L2 UE-to-Network Relay UE.

FIG. 8 shows a signaling diagram of a mobile-terminated location request (MT-LR) procedure, according to various embodiments of the present disclosure.

FIGS. 9A-B show a signaling diagram of a 5GC-MT-LR Procedure for a commercial location service, according to various embodiments of the present disclosure.

FIG. 10 shows a signal flow diagram of a procedure between a target UE, a reference (or relay) UE, an AMF, and a GMLC, according to various embodiments of the present disclosure.

FIG. 11 shows a signal flow diagram of a procedure between a proSe network function (NF), an LMF, an AMF, and a GMLC according to various embodiments of the present disclosure.

FIG. 12 shows an ASN.1 data structure for an exemplary Paging message sent by a RAN node, according to various embodiments of the present disclosure.

FIG. 13 shows exemplary protocol layers that can be used for transporting LPP messages between a remote (or out-of-coverage) target UE and the target UE's LMF, via a reference (or relay) UE, according to various embodiments of the present disclosure.

FIG. 14 shows a flow diagram of an exemplary method (e.g., procedure) for a core network node (CNN, e.g., AMF), according to various embodiments of the present disclosure.

FIG. 15 shows a flow diagram of an exemplary method (e.g., procedure) for a positioning node (e.g., LMF), according to various embodiments of the present disclosure.

FIG. 16 shows a communication system according to various embodiments of the present disclosure.

FIG. 17 shows a UE according to various embodiments of the present disclosure.

FIG. 18 shows a network node according to various embodiments of the present disclosure.

FIG. 19 shows host computing system according to various embodiments of the present disclosure.

FIG. 20 is a block diagram of a virtualization environment in which functions implemented by some embodiments of the present disclosure may be virtualized.

FIG. 21 illustrates communication between a host computing system, a network node, and a UE via multiple connections, at least one of which is wireless, according to various embodiments of the present disclosure.

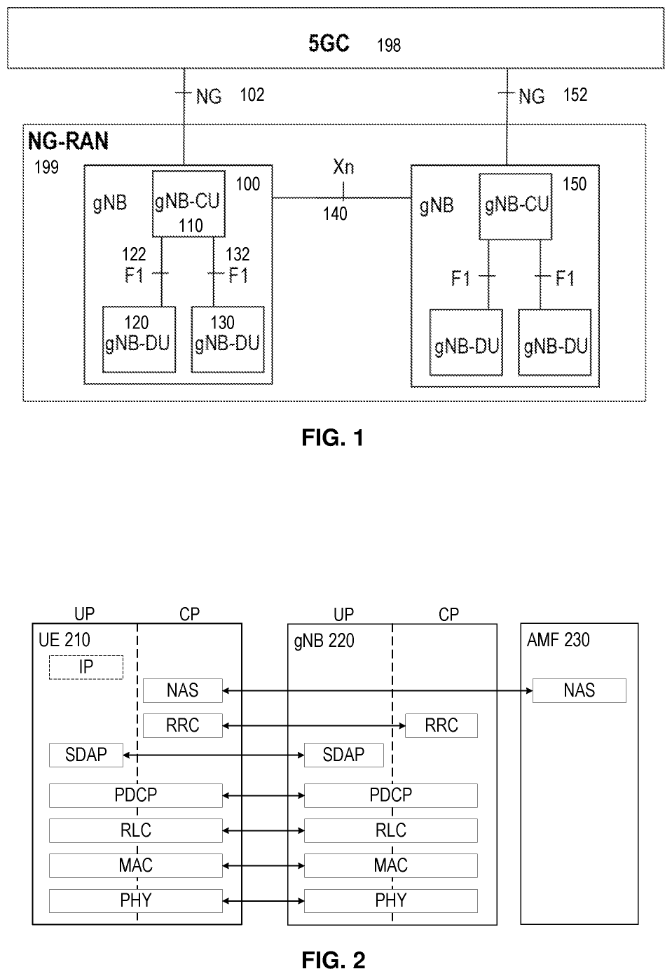

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Location server: As used herein, “location server” can refer to a network node with positioning functionality, e.g., ability to provide assistance data and/or request positioning measurements and/or calculate a location based on positioning measurements. A location server may or may not be part of a base station.
Positioning signals: As used herein, “positioning signals” may include any signal or channel to be received by the UE for performing a positioning measurement such as a DL reference signal, PRS, SSB, synchronization signal, DM-RS, CSI-RS, etc.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), and/or identifier detection/measurement (e.g., cell ID, beam ID, etc.) that are configured for a positioning method (e.g., OTDOA, E-CID, etc.). UE positioning measurements may be reported to a network node or may be used for positioning purposes by the UE.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

Positioning-related information, such as assistance data and positioning measurements, can be communicated between network and UE via user plane (UP) or control plane (CP). FIG. 2 shows an exemplary configuration of NR user plane (UP) and control plane (CP) protocol stacks between a UE, a gNB, and an access and mobility management function (AMF) in the 5GC. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on physical downlink control channel (PDCCH) for pages from 5GC via the gNB.

An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

Three important functional elements of the 3GPP positioning architecture are location services (LCS) Client, LCS target, and LCS Server. The LCS Server is a physical or logical entity (e.g., a location server) that manages positioning for an LCS target (e.g., a UE) by collecting measurements and other location information, assisting the LCS target in measurements when necessary, and estimating the LCS target location. An LCS Client is a software and/or hardware entity that interacts with an LCS Server for the purpose of obtaining location information for one or more LCS targets (i.e., the entities being positioned) such as a UE. LCS Clients may also reside in the LCS targets themselves. An LCS Client sends a request to an LCS Server to obtain location information, and the LCS Server processes and serves the received requests and sends the positioning result and optionally a velocity estimate to the LCS Client. A positioning request can be originated from the terminal or a network node or external client. Position calculation can be conducted, for example, by the LCS Server (e.g., E-SMLC or SLP) or by the LCS target (e.g., a UE).

Additionally, the following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. GNSS information retrieved by the UE, supported by assistance information provided to the UE from the E-SMLC.
OTDOA (Observed Time Difference of Arrival). The UE receives and measures Global Navigation Satellite System (GNSS) signals, supported by assistance information provided to the UE from E-SMLC.
UTDOA (Uplink TDOA). The UE is requested to transmit a specific waveform that is detected by multiple location measurement units (LMUs, which may be standalone, co-located or integrated into an eNB) at known positions. These measurements are forwarded to the E-SMLC for multilateration.
Multi-RTT: The device (e.g., UE) computes UE Rx-Tx time difference and gNBs compute gNB Rx-Tx time difference. The results are combined to find the UE position based upon round trip time (RTT) calculation.
DL angle of departure (DL-AoD): gNB or LMF calculates the UE angular position based upon UE DL RSRP measurement results (e.g., of PRS transmitted by network nodes).
UL angle of arrival (UL-AoA): gNB calculates the UL AoA based upon measurements of a UE's UL SRS transmissions.

In addition, one or more of the following positioning modes can be utilized in each of the positioning methods listed above:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.
   The detailed assistance data may include information about network node locations, beam directions, etc. The assistance data can be provided to the UE via unicast or via broadcast.

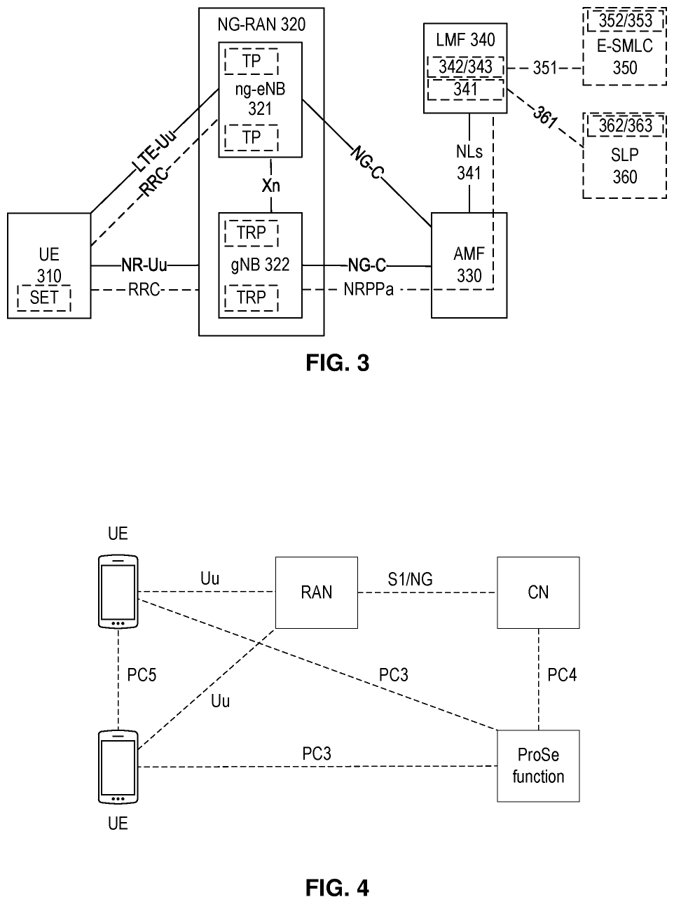

FIG. 3 is a block diagram illustrating a high-level architecture for supporting UE positioning in NR networks. NG-RAN 320 can include nodes such as gNB 322 and ng-eNB 321. Each ng-eNB may control several transmission points (TPs), such as remote radio heads. Similarly, each gNB may control several TRPs. Some or all of the TPs/TRPs may be DL-PRS-only for support of PRS-based TBS.

In addition, the NG-RAN nodes communicate with an AMF 340 in the 5GC via respective NG-C interfaces, while AMF 340 communicates with a location management function (LMF) 330 communicate via an NLs interface 341. An LMF supports various functions related to determination of UE locations, including location determination for a UE and obtaining DL location measurements or a location estimate from the UE, UL location measurements from the NG RAN, and non-UE associated assistance data from the NG RAN.

In addition, positioning-related communication between UE 310 and the NG-RAN nodes occurs via the RRC protocol, while positioning-related communication between NG-RAN nodes and LMF occurs via an NRPPa protocol. Optionally, the LMF can also communicate with an enhanced serving mobile location center (E-SMLC) 350 and a secure user plane location (SUPL) location platform (SLP) 360 in an LTE network via communication interfaces 351 and 361, respectively. Communication interfaces 351 and 361 can utilize and/or be based on standardized protocols, proprietary protocols, or a combination thereof.

LMF 340 can also include, or be associated with, various processing circuitry 342, by which the LMF performs various operations described herein. Processing circuitry 342 can include similar types of processing circuitry as described herein in relation to other network nodes (see, e.g., descriptions of FIGS. 18 and 20). LMF 340 can also include, or be associated with, a non-transitory computer-readable medium 343 storing instructions (also referred to as a computer program program) that can facilitate the operations of processing circuitry 342. Medium 343 can include similar types of computer memory as described herein in relation to other network nodes (see, e.g., descriptions of FIGS. 18 and 20). Additionally, LMF 340 can include various communication interface circuitry 341 (e.g., Ethernet, optical, and/or radio transceivers) that can be used, e.g., for communication via the NLs interface. For example, communication interface circuitry 341 can be similar to other interface circuitry described herein in relation to other network nodes (see, e.g., descriptions of FIGS. 18 and 20).

Similarly, E-SMLC 350 can also include, or be associated with, various processing circuitry 352, by which the E-SMLC performs various operations described herein. Processing circuitry 352 can include similar types of processing circuitry as described herein in relation to other network nodes (see, e.g., descriptions of FIGS. 18 and 20). E-SMLC 350 can also include, or be associated with, a non-transitory computer-readable medium 353 storing instructions (also referred to as a computer program program) that can facilitate the operations of processing circuitry 352. Medium 353 can include similar types of computer memory as described herein in relation to other network nodes (see, e.g., descriptions of FIGS. 18 and 20). E-SMLC 350 can also have communication interface circuitry that is appropriate for communicating via interface 351, which can be similar to other interface circuitry described herein in relation to other network nodes (see, e.g., descriptions of FIGS. 18 and 20).

Similarly, SLP 360 can also include, or be associated with, various processing circuitry 362, by which the SLP performs various operations described herein. Processing circuitry 362 can include similar types of processing circuitry as described herein in relation to other network nodes (see, e.g., descriptions of FIGS. 18 and 20). SLP 360 can also include, or be associated with, a non-transitory computer-readable medium 363 storing instructions (also referred to as a computer program program) that can facilitate the operations of processing circuitry 362. Medium 363 can include similar types of computer memory as described herein in relation to other network nodes (see, e.g., descriptions of FIGS. 18 and 20). SLP 360 can also have communication interface circuitry that is appropriate for communicating via interface 361, which can be similar to other interface circuitry described herein in relation to other network nodes (see, e.g., descriptions of FIGS. 18 and 20).

In a typical operation, the AMF can receive a request for a location service associated with a particular target UE from another entity (e.g., a gateway mobile location center (GMLC)), or the AMF itself can initiate some location service on behalf of a particular target UE (e.g., for an emergency call from the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

An LMF may have a signaling connection to an E-SMLC, enabling the LMF to access information from E-UTRAN, e.g., to support E-UTRA OTDOA positioning using downlink measurements obtained by a target UE. An LMF can also have a signaling connection to an SLP, the LTE entity responsible for user-plane positioning.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., location server). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that are to be used for OTDOA positioning measurements by the UE.

A vehicle-to-everything (V2X) UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface. FIG. 4 shows an exemplary arrangement of interfaces between two V2X UEs and a RAN. In addition to Uu and PC5 interfaces, the V2X UEs can communicate with a ProSe (PROximity-based SErvices) function via respective PC3 interfaces. Communication with the ProSe function requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

Broadcast, groupcast, and unicast transmissions are desirable for the services targeted by NR Sidelink (SL). In groupcast (or multicast), the intended receiver of a message consists of only a subset of the possible recipients in proximity to the transmitter, whereas a unicast message is intended for only one recipient in proximity to the transmitter. For example, in the platooning service there are certain messages that are only of interest of the members of the platoon, for which groupcast can be used. Unicast is a natural fit for use cases involving only a pair of vehicles.

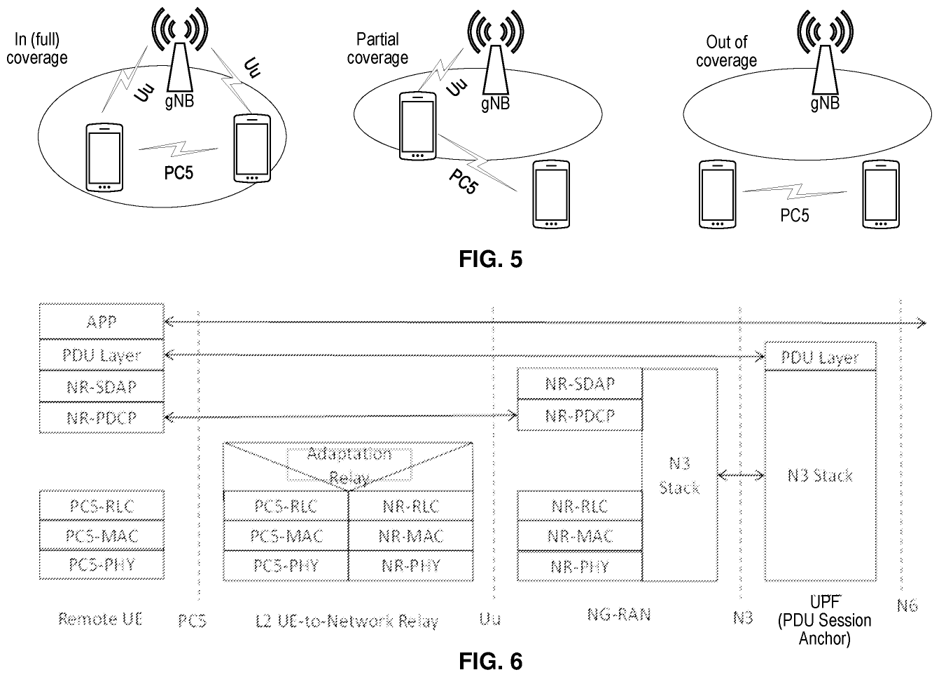

Furthermore, NR SL is designed such that it is operable both with and without network coverage and with varying degrees of interaction between the UEs (user equipment) and the RAN, including support for standalone, network-less operation. FIG. 5 shows three exemplary network coverage scenarios for two UEs and a gNB serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In the present Application, the term “SL standalone” is used to refer to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. A “peer UE” refers to a UE that can communicate with the out-of-coverage UE via SL standalone or SL relay (in which case the peer UE is also a relay UE).

UEs that are in coverage can be configured (e.g., by a gNB) via RRC signaling and/or system information. Out-of-coverage UEs rely on a (pre-) configuration available in their SIMs. These pre-configurations are generally static but can be updated by the network when a UE is in coverage.

3GPP TR 23.752 (v0.3.0) section 6.7 describes a layer-2 UE-to-Network Relay functionality supported for NR SL. This functionality can provide connectivity to NG-RAN by remote UEs that have successfully established PC5 links to a L2 UE-to-Network Relay UE (also referred to as “relay UE” for simplicity). A remote UE can be located within NG-RAN coverage or outside of NG-RAN coverage. The relay UE can forward (or relay) any type of traffic received from the remote UE over the PC5 interface (discussed above).

FIG. 6 illustrates an exemplary user plane (UP) SL protocol stack for a protocol data unit (PDU) Session, including a L2 UE-to-Network Relay UE. Below the application (APP) layer, the PDU layer carries data between the remote UE and the user plane function (UPF) in the 5GC, as part of the PDU session. In contrast, the PDCP layer is terminated at the remote UE and the gNB, and the L2 relay function is below PDCP. One consequence is that user data security is ensured between the remote UE and the gNB without exposing user data at the relay UE.

The Adaptation Relay layer within the relay UE can differentiate between signaling radio bearers (SRBs) and data radio bearers (DRBs) for a particular remote UE. The Adaptation Relay layer is also responsible for mapping PC5 traffic to one or more DRBs of the Uu. 3GPP RAN WG2 is responsible for the definition of the Adaptation Relay layer.

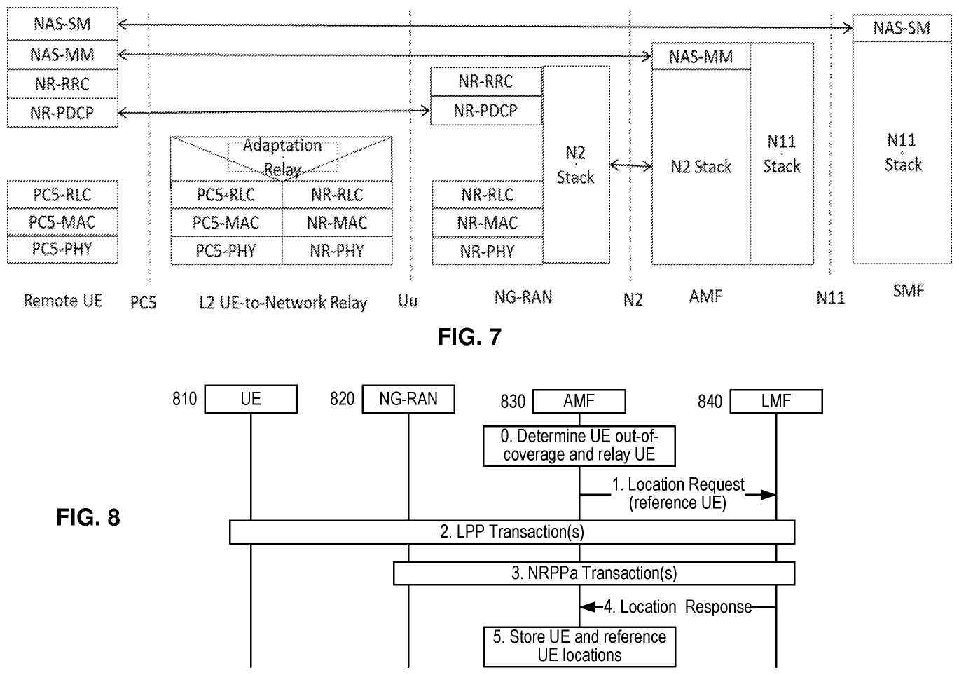

FIG. 7 illustrates an exemplary control plane (CP) SL protocol stack for non-access stratum (NAS) messages, including a L2 UE-to-Network Relay UE. The NAS connection is between the remote UE and the AMF (for NAS-MM) and a session management function (SMF, for NAS-SM). The NAS messages are transparently transferred between the remote UE and 5G-AN via the relay UE. In particular, the relay UE forwards SRB messages without any modification. Moreover, the relay UE uses the same protocol stack for forwarding both CP messages and UP PDUs, as illustrated in FIGS. 6-7.

NSPS positioning scenarios and/or use cases are expected to be important for 3GPP Rel-17. Certain NR SL features that were specified in 3GPP Rel-16 are likely to be the baseline for enhancements to NSPS positioning use cases. NSPS services may need to operate without (or with partial) RAN coverage, such as during indoor firefighting, forest firefighting, earthquake rescue, sea rescue, etc. In these scenarios, coverage extension is a crucial enabler for NSPS. 3GPP Rel-17 includes a study item for coverage extension for SL-based communication, including UE-to-network relay for cellular coverage extension and UE-to-UE relay for SL coverage extension.

Accordingly, SL-based positioning is expected to be important for NSPS scenarios and/or use cases in which UEs are (at least partially) out of network coverage. There are some ways for an out-of-coverage UE to perform positioning via SL connection with a UE that is in coverage. For example, the out-of-coverage UE may identify its relative or even absolute position based upon the known position of the in-coverage UE.

Additionally, SL-based positioning requires the UE to be capable of UE-based positioning (i.e., able to compute its own position) and that the LCS client is within the UE (UE premises). In some cases, however, the LCS client is external to the network and/or the UE can provide measurement results but can't compute its own position. In these cases, there is a need to provide assistance data and/or obtain positioning measurements from such UEs in partial coverage or out-of-coverage. Additionally, certain positioning applications have latency requirements for results (e.g., position or measurements) that may be difficult to meet due to the longer duration to determine a position for an out-of-coverage UE.

Accordingly, embodiments of the present disclosure address these and other problems, issues, and/or difficulties by providing techniques for a network node (e.g., AMF) to determine if a UE is out of RAN coverage before triggering a service request procedure or before triggering a positioning request towards a positioning node (e.g., LMF). Additionally, the network node (e.g., AMF) can inform a second positioning node (e.g., GMLC) that the UE is out of RAN coverage and, consequently, determining the UE's location may take longer than typical, normal, and/or expected.

Embodiments can provide various benefits and/or advantages. For example, embodiments can facilitate network support for mobile-terminated location requests (MT-LR) for a target UE operating out of RAN coverage with only a SL connection to another UE. Additionally, embodiments can provide early indication to requesting applications (e.g., LCS clients) that there may be delay in fulfilling a location request for an out-of-coverage target UE, thereby enabling requesting applications to take appropriate action in a timely manner. Also, embodiments can enable identification for positioning purposes of peer UE(s) for an out-of-coverage target UE, thereby facilitating positioning of the out-of-coverage target UE in accordance with a request.

FIG. 8 shows a signaling diagram of a mobile-terminated location request (MT-LR) procedure between a UE (810), an NG-RAN (820, an AMF (830), and an LMF (840). Although the operations shown in FIG. 8 are given numbers, this is done to facilitate explanation rather than to imply or require any particular operational order, unless expressly stated otherwise.

In operation 0, the AMF determines whether the UE-which is a target UE for positioning—is out-of-coverage or in-coverage with respect to NG-RAN. If the target UE is determined to be out-of-coverage, the AMF identifies a suitable reference (or relay) UE that can reach the target UE with one or multiple hops. The terms “reference UE” and “relay UE” are used interchangeably herein in the descriptions of various embodiments, with the phrases “reference (or relay)” and “relay (or reference)” being used occasionally to denote this interchangeability.

Operation 0 can be performed based on previous information, assistance from gNBs in the NG-RAN, or as part of a paging response procedure. In operation 1, the AMF sends a location request to the LMF for the target UE and may include an associated QoS. If the target UE is out-of-coverage with respect to NG-RAN, the AMF includes an identifier of the reference UE.

In operation 2, the LMF may obtain location-related information from the out-of-coverage target UE, the reference UE, and/or from a serving NG-RAN node. In the former case, the LMF instigates one or more LPP procedures to transfer UE positioning capabilities, provide assistance data to the target UE and/or obtain location information from the target UE. The UE may also instigate one or more LPP procedures after the first LPP message is received from the LMF (e.g., to request assistance data from the LMF).

In operation 3, if the LMF needs location-related information for the target UE from NG-RAN, the LMF instigates one or more NRPPa procedures. Operation 3 is not necessarily after operation 2; if the LMF and the NG-RAN have the information to determine what procedures need to take place for the location service, operation 3 could precede or overlap with operation 2. In operation 4, the LMF returns a location response to the AMF with any location estimate obtained as a result of operations 2-3. In operation 5, the AMF stores the last known location of the out-of-coverage target UE and the associated reference UE.

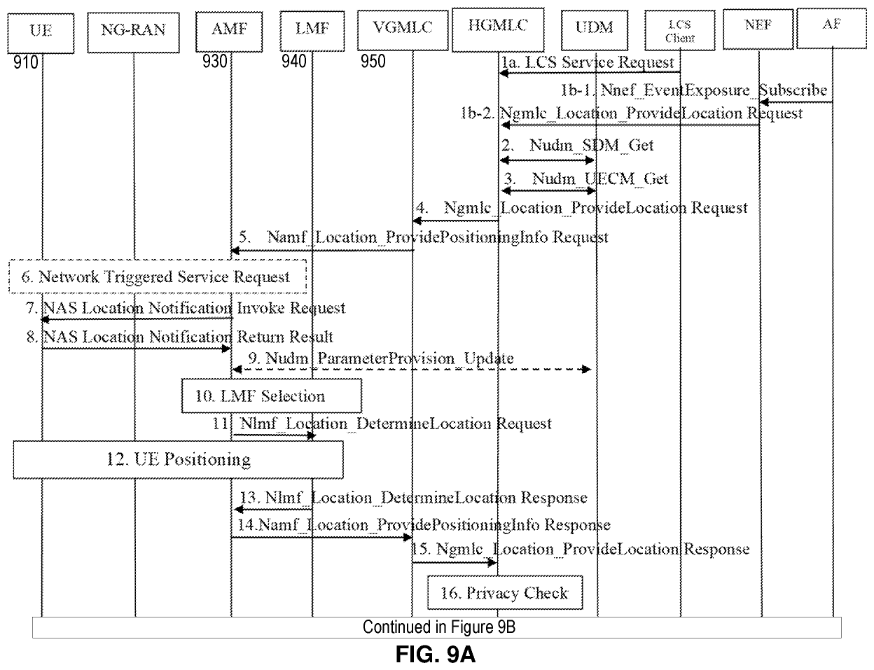

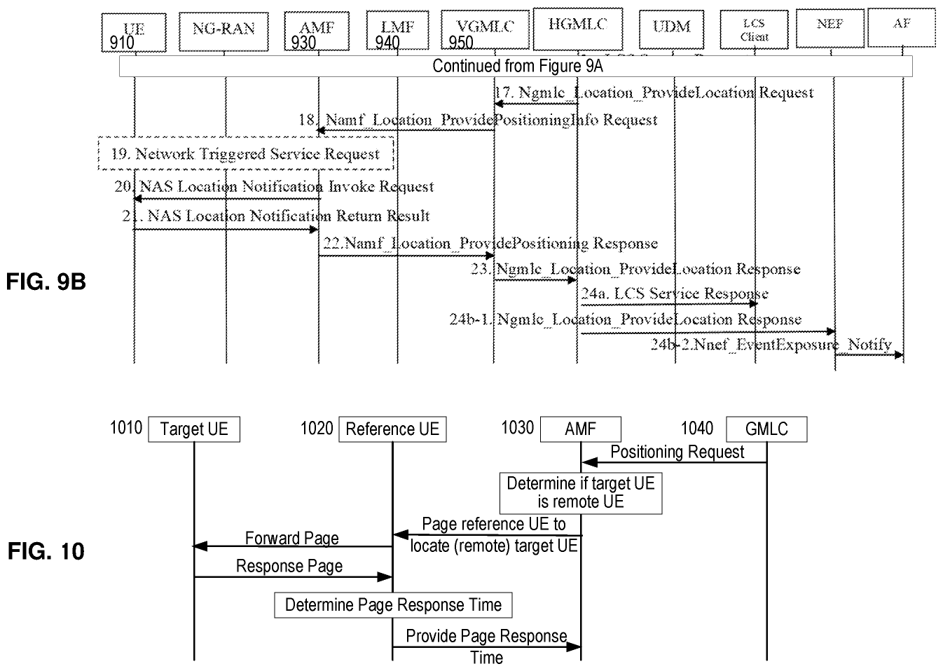

FIGS. 9A-B show a signaling diagram of a 5GC-MT-LR Procedure for a commercial location service, which corresponds to FIG. 6.1.2-1 of 3GPP TS 23.273 (v17.1.0) section 6.1.2. Section 6.1.2 of that specification describes the numbered operations in FIGS. 9A-B in detail. The following description is for operations that are modified to support positioning of an out-of-coverage target UE (910) based on L2-relay procedures, such as described above.

Operations 1-5 proceed as described in 3GPP TS 23.273. In operation 6, if the target UE is in CM IDLE state, the AMF (930) initiates a network-triggered Service Request procedure (as defined in 3GPP TS 23.502 section 4.2.3.3) to establish a signaling connection with the target UE. Before triggering the Service Request procedure, the AMF may determine whether the target UE is out-of-coverage based on the target UE's last location and/or when the last registration was received from the target UE (e.g., during some previous time period). If the AMF determines that the target UE is out-of-coverage, the AMF may indicate this to GMLC (950) and also that the time required to position the target UE may be longer than expected (i.e., as a consequence of being out-of-coverage). As part of the Service Request procedure, the AMF may determine a reference (or relay) UE that can reach the out-of-coverage target UE with one or multiple hops. In other words, the AMF can determine whether it is possible to configure partial coverage for the out-of-coverage target UE.

Operations 7-10 proceed as described in 3GPP TS 23.273. In operation 11, the AMF may indicate to the LMF (940) that the target UE is out-of-coverage and provide an identifier of the reference UE to the LMF. Based on receiving this information, the LMF can perform one or more of the positioning procedures described in 3GPP TS 23.273 (v17.1.0) sections 6.11.1-6.11.3 towards the reference UE. Operations 12-24 proceed as described in 3GPP TS 23.273.

Table 1 below shows an exemplary set of enumerated values by which the AMF can indicate conditions related to SL-based positioning determination. For example, this table can be included in a specification such as 3GPP TS 24.571.

Table 2 below shows an exemplary data structure that the LMF can send in response to receiving from the AMF an indication such as shown in Table 1. For example, this table can be included in a specification such as 3GPP TS 24.571. The “LocationData” field and the last “ProblemDetails” field are of particular interest to the present disclosure.

TABLE 1

| Enumerated value | Description/meaning |
|---|---|
| “UE_AVAILABLE” | UE available event |
| “PERIODIC” | Periodic event |
| “ENTERING_INTO_AREA” | Entering area event |
| “LEAVING_FROM_AREA” | Leaving area event |
| “BEING_INSIDE_AREA” | Being inside area event |
| “MOTION” | Motion event |
| “PARTIAL_COVERAGE” | Partial Coverage event |
| “OUT_OF_COVERAGE” | Out of Coverage event |

TABLE 2

| | | | Response | |
|---|---|---|---|---|
| Data type | P | Cardinality | codes | Description |
| LocationData | M | 1 | 200 OK | This case represents the successful |
| | | | | retrieval of the location of the UE or |
| | | | | successful activation of periodic or |
| | | | | triggered location in the UE. |
| | | | | Upon success, a response body is |
| | | | | returned containing the different |
| | | | | parameters of the location data if |
| | | | | obtained, such as: |
| | | | | Geographic Area |
| | | | | Civic Location |
| | | | | Local location, |
| | | | | Positioning methods, |
| | | | | Distance from cellular coverage |
| n/a | | | 204 No | This case represents the successful |
| | | | Content | delivery of location assistance data to |
| | | | | the UE, during MO-LR requesting for |
| | | | | location assistance data for the UE. |
| RedirectResponse | O | 0 . . . 1 | 307 | Temporary redirection. The response |
| | | | Temporary | shall include a Location header field |
| | | | Redirect | containing a different URI, or the same |
| | | | | URI if a request is redirected to the |
| | | | | same target resource via a different |
| | | | | SCP. In the former case, the URI shall |
| | | | | be an alternative URI of the resource |
| | | | | located on an alternative service |
| | | | | instance within the same LMF or LMF |
| | | | | (service) set. |
| RedirectResponse | O | 0 . . . 1 | 308 | Permanent redirection. The response |
| | | | Permanent | shall include a Location header field |
| | | | Redirect | containing a different URI, or the same |
| | | | | URI if a request is redirected to the |
| | | | | same target resource via a different |
| | | | | SCP. In the former case, the URI shall |
| | | | | be an alternative URI of the resource |
| | | | | located on an alternative service |
| | | | | instance within the same LMF or LMF |
| | | | | (service) set. |
| ProblemDetails | O | 0 . . . 1 | 403 | The “cause” attribute may be used to |
| | | | Forbidden | indicate the following application |
| | | | | errors: |
| | | | | POSITIONING_DENIED |
| | | | | UNSPECIFIED |
| | | | | UNSUPPORTED_BY_UE |
| | | | | See 3GPP TS 24.571 table 6.1.7.3-1 |
| | | | | for the description of these errors. |
| ProblemDetails | O | 0 . . . 1 | 500 | The “cause” attribute may be used to |
| | | | Internal | indicate the following application |
| | | | Server | error: |
| | | | Error | POSITIONING_FAILED |
| | | | | See 3GPP TS 24.571 table 6.1.7.3-1 |
| | | | | for the description of these errors. |
| ProblemDetails | O | 0 . . . 1 | 504 | The “cause” attribute may be used to |
| | | | Gateway | indicate the following application |
| | | | Timeout | error: |
| | | | | UNREACHABLE_USER |
| | | | | See 3GPP TS 24.571 table 6.1.7.3-1 |
| | | | | for the description of this error. |
| ProblemDetails | O | 0 . . . 1 | 50X | The “cause” attribute may be used to |
| | | | No Relay | indicate the following application |
| | | | UE Found | error: OUT_OF_COVERAGE |

NOTE:
The mandatory HTTP error status codes for the POST method listed in Table 5.2.7.1-1 of 3GPP TS 29.500 other than those specified in the table above also apply, with a ProblemDetails data type (see clause 5.2.7 of 3GPP TS 29.500).

In some embodiments, the AMF can maintain a database for storing information about out-of-coverage UEs, such as last known location and an associated reference (or relay) UE. The AMF can update the stored information for each UE after every positioning session for that UE is a positioning target. Alternately, such information can be stored in UDM/Unified Data Repository (UDR).

In some embodiments, the AMF can determine that a target UE is present but out-of-coverage based on the target UE having previously authenticated with the network or having sent a registration request. The out-of-coverage target UE may have performed either of these procedures directly (via direct NAS signaling with the network) or via a reference (or relay) UE that forward the UE's NAS messages to the network. Additionally, the reference UE may have performed either of these procedures on behalf of the out-of-coverage target UE. As another alternative, the reference UE may inform the AMF that it is connected to an out-of-coverage target UE and provide information about this target UE and, optionally, one or more other out-of-coverage UEs to which it is connected.

Based on determining that the target UE is present but out-of-coverage in any of the ways discussed above, the AMF can update its database entry for that UE accordingly. In some embodiments, upon receiving from GMLC a positioning request that identifies the UE as a target UE, the AMF may check its database to determine whether the UE is out-of-coverage. If the UE is out-of-coverage, the AMF may indicate to GMLC that the UE is an out-of-coverage target UE, such as discussed above.

In some embodiments, the AMF can determine a reference (or relay) UE for an out-of-coverage (or remote) target UE or verify that the target UE is still reachable through a previously determined reference UE. For example, a special paging procedure can be initiated by the AMF towards a current or potential reference UE for an out-of-coverage target UE. Upon receiving the page from the AMF, the current or potential reference UE can forward the page to the out-of-coverage target UE, listen for a page response, and report the result to the AMF. If the current or potential reference UE reports a page response from the out-of-coverage target UE, the AMF can select the potential reference UE as the current reference UE, or renew the selection of the current reference UE, as the case may be.

FIG. 10 shows a signal flow diagram of a procedure between a target UE (1010), a reference (or relay) UE (1020), an AMF (1030), and a GMLC (1040) according to these embodiments. Initially, the GMLF sends the AMF a positioning request that identifies the target UE. The AMF then determines whether the target UE is a remote (or out-of-coverage) UE, which in this example is true. The AMF may also identify a current reference (or relay) UE for the target UE from its database, or identify a potential reference UE if no current reference UE exists. Based on this determination, the AMF sends a page to the current or potential reference UE, which forwards the page to the out-of-coverage target UE. In this case, the remote UE responds. The relay UE determines a corresponding page response time and sends this information to the AMF. Although not shown, the AMF can provide the response time information (or other information derived therefrom) to the GMLC, such as discussed above.

In some cases, AMF may already be aware of a reference UE (e.g., in the database) or can determine one in the manner shown in FIG. 10. If there are multiple potential reference UEs or AMF is unable to determine a reference UE, the task for identification of a reference UE for the remote UE may be delegated to LMF which may follow certain criteria discussed in more detail below. Alternately, the proSe network function (NF) can also be queried for identification of a reference UE for the out-of-coverage (or remote) UE.

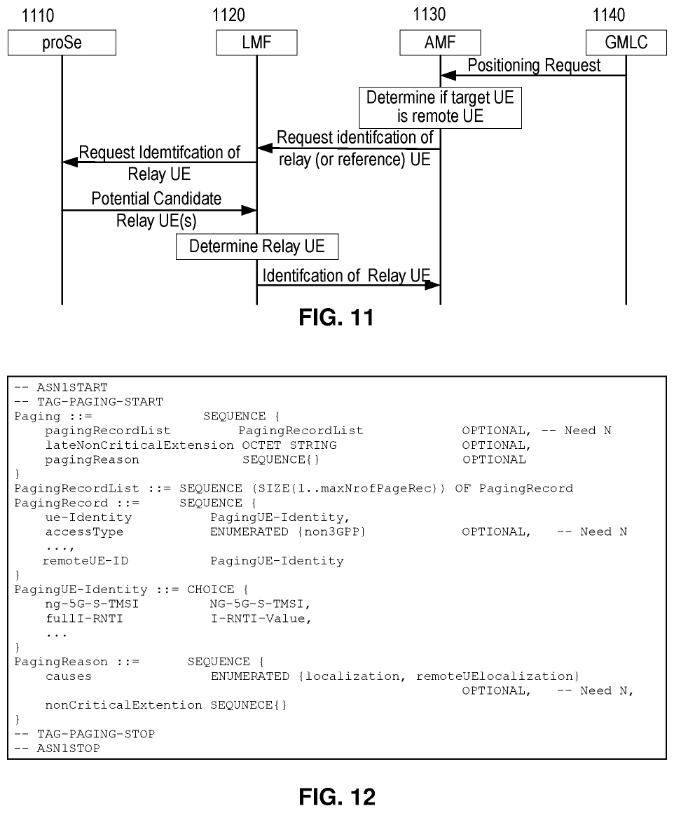

FIG. 11 shows a signal flow diagram of a procedure between a proSe NF (1110), an LMF (1120), an AMF (1130), and a GMLC (1140) according to these embodiments. In this example, the AMF requests the LMF to identify a relay (or reference) UE for an out-of-coverage (or remote) target UE, and the LMF requests the proSe NF to identify a relay UE for the remote UE. The proSe NF provides one or more potential relay UEs to the LMF, which determines and/or selects a particular one of these and indicates the selection to the AMF (not shown).

The LMF can select a relay UE for the remote UE in various ways. In some embodiments, the LMF can evaluate multipath report from the candidate relay UEs. For example, the LMF can look for reports in which the first (shortest) path is the strongest (e.g., highest RSRP measurement), which suggests that the candidate relay UE has LOS with the serving RAN node. The LMF can also compare the reported RSRP for the first path to an RSRP expected for LOS. In some embodiments, the LMF can evaluate timing and/or range measurements for the candidate relay UEs, e.g., to determine which is closest to the serving RAN node. In some embodiments, the LMF can select a relay UE for the remote UE based on one or more of the following:
Degree of stationarity. Stationary UEs are preferable, since their locations are established and known. In some cases, a network operator (or service provider) can install fixed UEs that can be dedicated as relay UEs for proximate target UEs.
Energy conditions. A relay UE may need to provide measurements on behalf of multiple target UEs, which can cause the relay UE to consume more energy. Thus, the AMF may consider energy source (e.g., battery, charger, mains), remaining stored energy (e.g., in battery), etc. when selecting a relay UE.

As mentioned above, a special paging procedure can be initiated by the AMF towards a current or candidate relay UE for a remote UE. In some embodiments, a paging message used in such a procedure can includes a reason (or cause) indicating paging for location request. Based on receiving a paging message with this paging reason, a relay UE can record the time when the remote UE responds to the page and provide the timing information in the paging response.

Table 3 below shows one example of where a Paging Priority in a Paging message sent by an AMF can be updated to include additional values that indicate a paging is for location estimation or for remote UE localization

TABLE 3

| IE/Group Name | Pres. | IE type/ref. | Semantics description |
|---|---|---|---|
| Paging Priority | M | ENUMERATED (PrioLevel1, | Lower value codepoint |
| | | PrioLevel2, PrioLevel3, PrioLevel4, | indicates higher priority. |
| | | PrioLevel5, PrioLevel6, PrioLevel7, | |
| | | PrioLevel8, . . . | |
| | | locationEstimation, | |
| | | remoteUE-Localization) | |

Table 4 below shows another example of where the Paging message sent by an AMF can be updated to include an additional “Paging Reason” field that indicate a paging is for location estimation or for remote UE localization, as well as a “Remote UE identity” that includes an identifier (e.g., IMSI) of the remote UE to be paged by the relay UE.

TABLE 4

| | | | | Semantics |
|---|---|---|---|---|
| IE/Group Name | Pres. | Range | IE type/ref. | description |
| Message Type | M | | 9.3.1.1 | |
| UE Paging Identity | M | | 9.3.3.18 | |
| Paging DRX | O | | 9.3.1.90 | |
| TAI List for Paging | | 1 | | |
| >TAI List for | | 1 . . . | | |
| Paging Item | | < maxnoofTAIforPaging> | | |
| >>TAI | M | | 9.3.3.11 | |
| Paging Priority | O | | 9.3.1.78 | |
| UE Radio Capability | O | | 9.3.1.68 | |
| for Paging | | | | |
| Paging Origin | O | | 9.3.3.22 | |
| Assistance Data for | O | | 9.3.1.69 | |
| Paging | | | | |
| NB-IoT Paging | O | | 9.3.1.138 | |
| eDRX Information | | | | |
| NB-IoT Paging | O | | 9.3.1.139 | If this IE is |
| DRX | | | | present, the |
| | | | | Paging DRX |
| | | | | IE is ignored. |
| Enhanced Coverage | O | | 9.3.1.140 | |
| Restriction | | | | |
| WUS Assistance | O | | 9.3.1.143 | |
| Information | | | | |
| Paging eDRX | O | | 9.3.1.154 | |
| Information | | | | |
| CE-mode-B | O | | 9.3.1.155 | |
| Restricted | | | | |
| Paging Reason | O | | ENUMERATED | |
| | | | (localization, | |
| | | | remoteUELocalization) | |
| Remote UE Identity | O | | IMSI of Remote UE | |

FIG. 12 shows an ASN.1 data structure for an exemplary Paging message sent by a RAN node in response to receiving a Paging message from the AMF according to any of the above-described embodiments. Of particular interest are the PagingReason field (which can take one of two enumerated values) and the remoteUE-ID field in the PagingRecord IE. The information in these fields can correspond to information provided to the RAN node by the AMF. The RAN node can send this Paging message to UEs in the area that it serves.

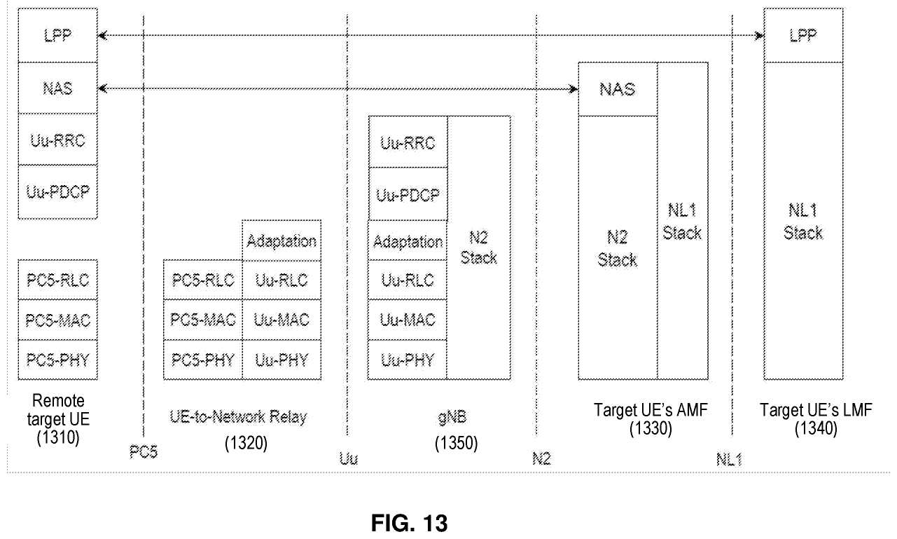

FIG. 13 shows exemplary CP protocol layers that can be used for transporting LPP messages between a remote (or out-of-coverage) target UE and the target UE's LMF, via a reference (or relay) UE. The arrangement shown in FIG. 13 is similar to the one shown in FIG. 7 except for addition of LMF (1340) and LPP layer that carries positioning assistance data, positioning measurements, etc. For example, LMF-provided assistance data is received by relay UE (1320) via an adaptation layer and sent to the target UE (1310) via PC5 link. Positioning measurements and SL-based measurements can be combined to identify target UE position. For example, the target UE can report timing measurement (e.g., Rx-Tx difference, TOA, TDOA, etc.) with time stamp to relay UE via PC5, which the relay UE reports to LMF together with SL measurements toward the target UE. The LMF can determine the position of the relay UE and/or the target UE based on this report. Note that FIG. 13 also shows the target UE's AMF (1330) and serving gNB (1330) of the relay UE.

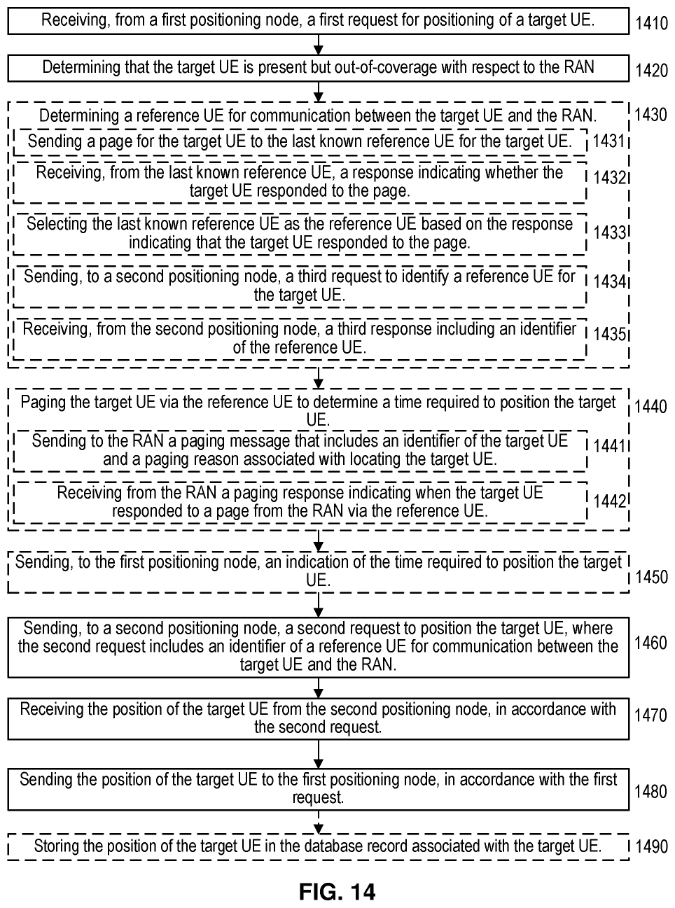

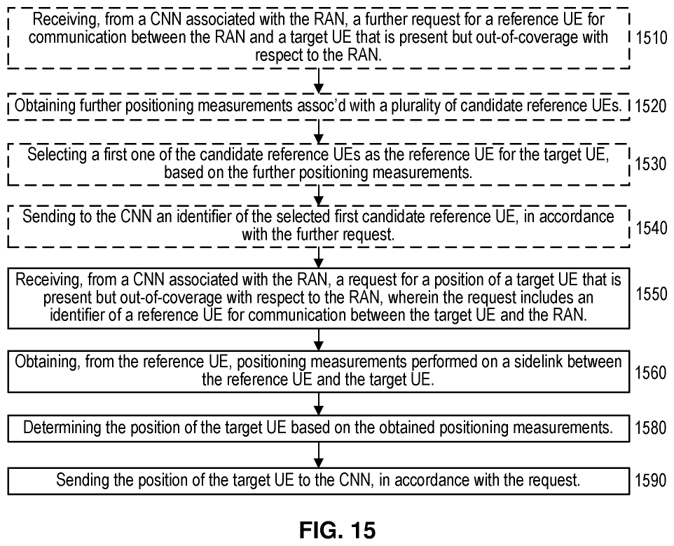

Various features of the embodiments described above correspond to various operations illustrated in FIGS. 14-15, which show exemplary methods (e.g., procedures) for a core network node (CNN) and a positioning node, respectively. In other words, various features of the operations described below correspond to various embodiments described above. Furthermore, the exemplary methods shown in FIGS. 14-15 can be used cooperatively to provide various benefits, advantages, and/or solutions to problems described herein. Although FIGS. 14-15 show specific blocks in particular orders, the operations of the exemplary methods can be performed in different orders than shown and can be combined and/or divided into blocks having different functionality than shown. Optional blocks or operations are indicated by dashed lines.

In particular, FIG. 14 shows an exemplary method (e.g., procedure) for a CNN configured to support positioning of UEs in a RAN, according to various embodiments of the present disclosure. The exemplary method can be performed by a CNN (e.g., AMF, etc.) such as described elsewhere herein.

The exemplary method can include the operations of block 1410, where the CNN can receive, from a first positioning node, a first request for positioning of a target UE. The exemplary method can also include the operations of block 1420, where the CNN can determine the following: that the target UE is present but out-of-coverage with respect to the RAN. The exemplary method can also include the operations of block 1460, where the CNN can send, to a second positioning node, a request to position the target UE. The request can include an identifier of a reference UE for communication between the target UE and the RAN. The exemplary method can also include the operations of blocks 1470-1480, where the CNN can receive the position of the target UE from the second positioning node, in accordance with the second request, and send the position of the target UE to the first positioning node, in accordance with the first request.

In some embodiments, the CNN is associated with a database that includes a plurality of records associated with a respective plurality of UEs, with each record including a last known location for a particular UE and a last known reference UE for the particular UE. In some of these embodiments, determining that the target UE is present but out-of-coverage with respect to the RAN (e.g., in block 1420) is based on a previous authentication by the target UE or a previous registration by the target UE. Additionally, the previous authentication or the previous registration was performed by the CNN directly with the target UE, or indirectly with the target UE via the reference UE.

In some of these embodiments, the exemplary method can also include the operations of block 1490, where the CNN can store the position of the target UE (e.g., received in block 1470) in the database record associated with the target UE.

In some embodiments, the exemplary method can also include the operations of block 1430, where the CNN can determine the reference UE for communicating between the target UE and the RAN. Different variants of these embodiments are possible.

In some of these embodiments, determining the reference UE for communication between the target UE and the RAN includes the following operations, labelled with corresponding sub-block numbers:
(1421) sending a page for the target UE to a last known reference UE for the target UE;
(1422) receiving, from the last known reference UE, a response indicating whether the target UE responded to the page; and
(1423) selecting the last known reference UE as the reference UE based on the response indicating that the target UE responded to the page.

In some of these embodiments, determining the reference UE for communication between the target UE and the RAN includes the following operations, labelled with corresponding sub-block numbers:
(1424) sending, to the second positioning node, a third request to identify a reference UE for communication between a target UE and the RAN; and
(1425) receiving, from the second positioning node, a third response including an identifier of a candidate reference UE selected by the second positioning node.

In some of these embodiments, the first positioning node is a GMLC, the second positioning node is an LMF, and CNN is an AMF. In some of these embodiments, the identifier candidate reference UE that is received from the second positioning node (e.g., in block sub-1425) is the identifier of a reference UE that is sent to the second positioning node in the second request (e.g., in block 1460).

In some of these embodiments, sending the request to identify a reference UE to the second positioning node in sub-block 1424 is based on one or more of the following:
a database record associated with the target UE does not include a last known reference UE; and
an indication (e.g., received in sub-block 1423) that the target UE did not respond to a page via the last known reference UE.

In some embodiments, the exemplary method can also include the operations of blocks 1440-1450, where in response to the first request (e.g., in block 1410), the CNN can page the target UE via the reference UE to determine a time required to position the target UE and send to the positioning node an indication of the time required to position the target UE. FIG. 10 shows an example of these embodiments.

In some of these embodiments, paging the target UE via the reference UE in block 1440 includes the following operations, labelled with corresponding sub-block numbers:
(1441) sending to the RAN a paging message that includes an identifier of the target UE and a paging reason associated with locating the target UE; and
(1442) receiving from the RAN from the RAN a paging response indicating when the target UE responded to a page from the RAN via the reference UE.

In addition, FIG. 15 shows an exemplary method (e.g., procedure) for a positioning node associated with a RAN, according to various embodiments of the present disclosure. The exemplary method can be performed by a positioning node (e.g., LMF, E-SMLC, SUPL, etc.) such as described elsewhere herein.

The exemplary method can include the operations of block 1550, where the positioning node can receive, from a CNN associated with the RAN, a request for a position of a target UE that is present but out-of-coverage with respect to the RAN. The request includes an identifier of a reference UE for communication between the target UE and the RAN. The exemplary method can also include the operations of block 1560, where the positioning node can obtain, from the reference UE, positioning measurements performed on a sidelink between the reference UE and the target UE. The exemplary method can also include the operations of blocks 1570-1580, where the positioning node can determine the position of the target UE based on the obtained positioning measurements and send the position of the target UE to the CNN, in accordance with the request.

In some embodiments, the positioning node is an LMF and the CNN is an AMF.

In some embodiments, the obtained positioning measurements include first positioning measurements performed by the target UE and second positioning measurements performed by the reference UE. In some of these embodiments, the first positioning measurements performed by the target UE include timing measurements and/or power measurements (including power measurements per path if multiple paths exist) on signals transmitted by the reference UE.

In some of these embodiments, the second positioning measurements made by the reference UE can include any of the following:
timing measurements made by the reference UE on signals transmitted by the target UE;
power measurements made by the reference UE on signals transmitted by the target UE;
timing measurements made by the reference UE on signals transmitted by a RAN node;
power measurements made by the reference UE on signals transmitted by a RAN node; and
time-difference measurements made by the reference UE on signals transmitted by a plurality of RAN nodes.

In some embodiments, the exemplary method can also include the operations of blocks 1510-1520, where the positioning node can receive, from the CNN, a further request for a reference UE for communication between the target UE and the RAN and obtain further positioning measurements associated with a plurality of candidate reference UEs. In some of these embodiments, the further positioning measurements associated with each candidate reference UE includes one or more of the following:
one or more of the following measurements made by the candidate reference UE on signals transmitted by a RAN node: received power, and timing;
one or more of the following measurements made by the RAN node on signals transmitted by the candidate reference UE: received power, and timing; and
a degree of stationarity of the candidate reference UE; and
energy conditions associated with the candidate reference UE.

In some of these embodiments, the exemplary method can include the following operations, labelled with corresponding block numbers:
(1530) selecting a first one of the candidate reference UEs as the reference UE for the target UE, based on the further positioning measurements; and
(1540) sending to the CNN an identifier of the selected first candidate reference UE, in accordance with the further request.

In some variants, the first candidate reference UE can be selected as the reference UE for the target UE (e.g., in block 1530) based on one or more of the following:
line-of-sight to the RAN node, as indicated by the received power measurements;
closest to the RAN node, as indicated by the timing measurements;
most stationary of the candidate reference UEs; and
powered by mains or highest remaining stored energy of the candidate reference UEs.

In some of these embodiments, the identifier of the selected first candidate reference UE sent to the CNN (e.g., in block 1540) is the identifier of a reference UE that is received from the CNN in the request for a position of the target UE (e.g., in block 1550). Put differently, the CNN may use the reference UE identified in response to the further request in a subsequent request to position the target UE.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

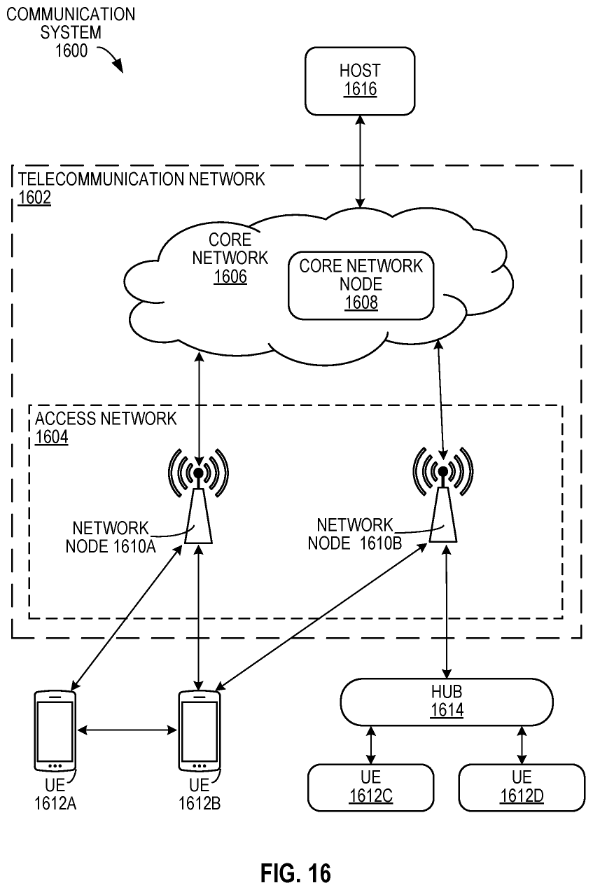

FIG. 16 shows an example of a communication system 1600 in accordance with some embodiments. In the example, the communication system 1600 includes a telecommunication network 1602 that includes an access network 1604, such as a RAN, and a core network 1606, which includes one or more core network nodes 1608. The access network 1604 includes one or more access network nodes, such as network nodes 1610a and 1610b (one or more of which may be generally referred to as network nodes 1610), or any other similar 3GPP access node or non-3GPP access point. The network nodes 1610 facilitate direct or indirect connection of UEs, such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Although not shown, in some embodiments core network 1606 can include one or more positioning nodes, such as positioning nodes shown in or described in relation to other figures herein. In such embodiments, the one or more positioning nodes can be among core network nodes 1608.

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

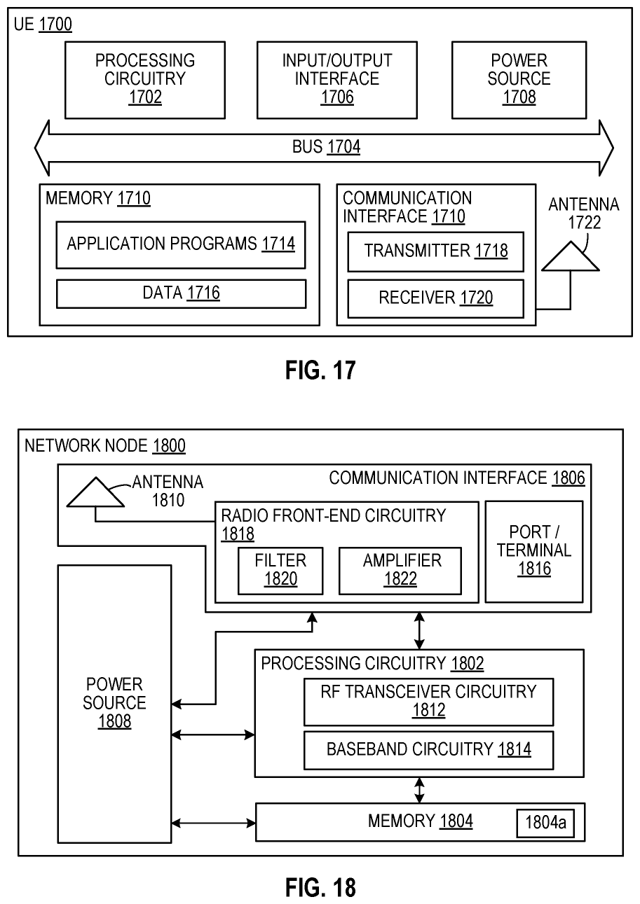

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network 20) or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an 30) animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O & M) nodes, Operations Support System (OSS) nodes, Self-Organizing Network (SON) nodes, positioning nodes (e.g., LMFs, E-SMLCs, GMLCs, etc.), core network nodes (e.g., MMEs, SGWs, AMFs, etc.), and/or Minimization of Drive Test (MDT)-related nodes.

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions (collectively denoted computer program product 1804a) capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel 25 and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different 30 combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

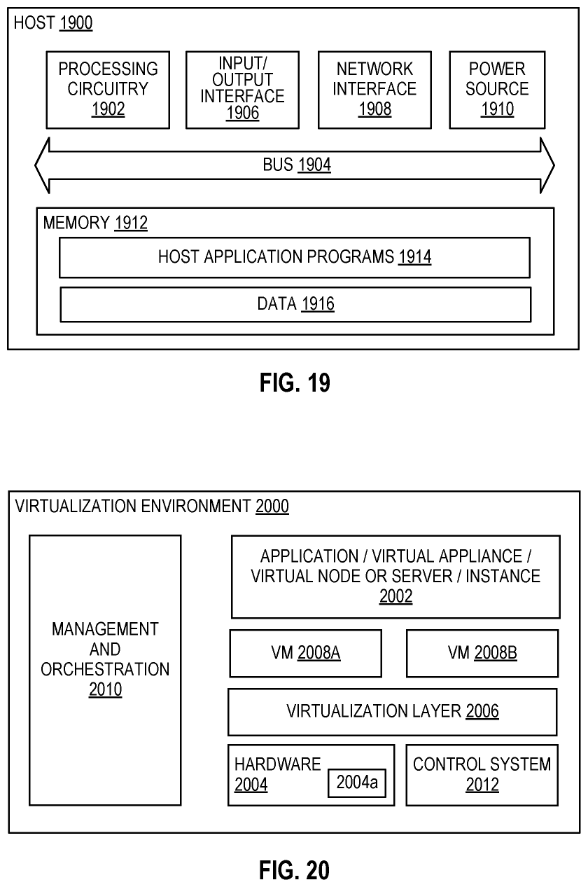

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 May select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 2000 to implement some of the features, functions, and/or benefits of some of the embodiments disclosed herein. As a specific example, one or more virtual network functions 2002 can be arranged in environment 2000 to perform operations attributed to a core network node (CNN) or to a positioning node in above descriptions of various procedures.

Hardware 2004 includes processing circuitry, memory that stores software and/or instructions (collectively denoted computer program product 2004a) executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

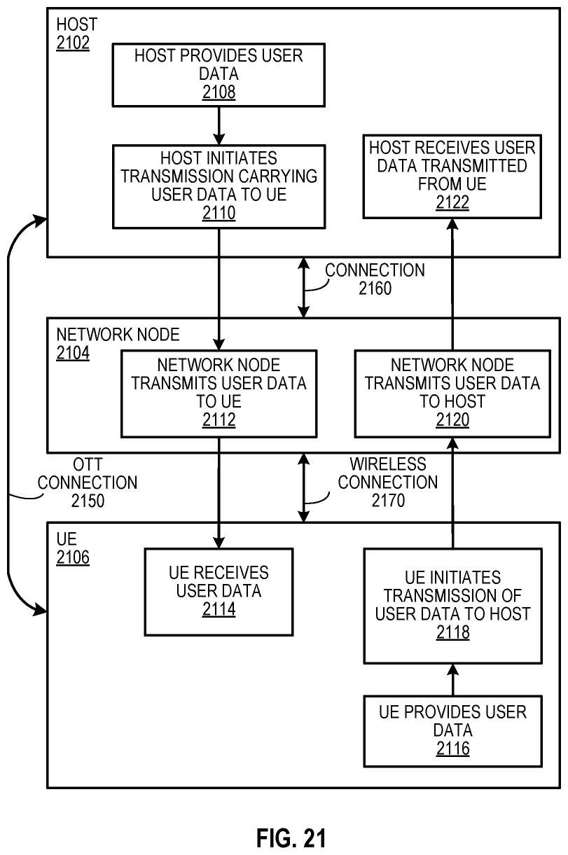

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, embodiments described herein can facilitate network positioning of a UE operating out of RAN coverage with only a SL connection to another UE. Additionally, embodiments can provide early indication to requesting applications that there may be delay in fulfilling a location request for an out-of-coverage UE, thereby enabling requesting applications to take appropriate action in a timely manner. Embodiments can enable identification for positioning purposes of relay UE(s) for an out-of-coverage UE, thereby facilitating positioning of the out-of-coverage UE in accordance with a request. In this manner, embodiments can improve the delivery of positioning-based OTT services by a wireless network, which increases the value of such services to end users and OTT service providers.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a core network node (CNN) configured to support positioning of user equipment (UEs) in a radio access network (RAN), the method comprising:
   receiving, from a first positioning node, a request for positioning of a UE;
   determining the following:
      that the UE is a remote UE that is present but out-of-coverage with respect to the RAN, and
      a relay UE for communication between the remote UE and the RAN;
   paging the remote UE via the relay UE to determine a time required to position the remote UE; and
   sending an indication of the time required to the first positioning node.
A2. The method of embodiment A1, wherein the CNN is associated with a database that includes a plurality of records associated with a respective plurality of UEs, each record including a last known location for a particular UE and a last known relay UE for the particular UE.
A3. The method of embodiment A2, wherein:
   determining that the UE is present but out-of-coverage with respect to the RAN is based on one of the following by the UE: a previous authentication, or a previous registration; and
   the previous authentication or the previous registration was performed by the CNN according to one of the following: directly with the UE, or indirectly with the UE via the relay UE.
A4. The method of any of embodiments A2-A3, wherein determining the relay UE for communication between the remote UE and the RAN comprises:
   sending a page for the remote UE to the last known relay UE for the remote UE;
   receiving, from the last known relay UE, a response indicating whether the remote UE responded to the page; and
   selecting the last known relay UE as the relay UE based on the response indicating that the remote UE responded to the page.
A5. The method of any of embodiments A2-A3, wherein determining the relay UE for communication between the remote UE and the RAN comprises:
   sending, to a second positioning node, a request to identify a relay UE for the remote UE; and
   receiving, from the second positioning node, a response including an identifier of the relay UE.
A6. The method of embodiment A5, wherein sending the request to identify a relay UE to the second positioning node is based on one or more of the following:
   the database record associated with the remote UE does not include a last known relay UE; and
   an indication that the remote UE did not respond to a page via the last known relay UE.
A7. The method of any of embodiments A1-A6, wherein paging the remote UE via the relay UE comprises:
   sending to the RAN a paging message that includes an identifier of the remote UE and a paging reason associated with locating the remote UE; and
   receiving from the RAN a paging response indicating when the remote UE responded to a page from the RAN via the relay UE.
A8. The method of any of embodiments A2-A7, further comprising sending, to a second positioning node, a request to position the remote UE, where the request includes an identifier of the relay UE.
A9. The method of embodiment A8, further comprising:
   receiving, from the second positioning node, a response indicating the position of the remote UE; and
   storing the position of the remote UE in the database record associated with the remote UE.
A10. The method of any of embodiments A8-A9, wherein the first positioning node is a gateway mobile location center (GMLC), the second positioning node is a location management function (LMF), and CNN is an access and mobility management function (AMF).
B1. A method for a positioning node associated with a radio access network (RAN), the method comprising:
   receiving, from a core network node (CNN) associated with the RAN, a request to identify a relay UE for communication between a remote UE and the RAN, wherein the remote UE is present but out-of-coverage with respect to the RAN;
   identifying a plurality of candidate relay UEs and obtaining positioning measurements from the plurality of candidate relay UEs;
   based on the obtained positioning measurements, selecting one of the candidate relay UEs as the relay UE for the remote UE; and
   sending to the CNN a response including an identifier of the selected relay UE.
B2. The method of embodiment B1, wherein the positioning measurements obtained from each particular candidate relay UE includes one or more of the following:
   one or more of the following measurements made by the particular candidate relay UE of signals transmitted by a RAN node: multipath received power, and timing;
   one or more of the following measurements made by the RAN node of signals transmitted by the particular candidate relay UE: multipath received power, and timing; and
   a degree of stationarity of the particular candidate relay UE; and
   energy conditions associated with the particular candidate relay UE.
B3. The method of embodiment B2, wherein the candidate relay UE is selected as the relay UE for the remote UE based on one or more of the following characteristics:
   line-of-sight to the RAN node, as indicated by the multipath received power measurements;
   closest to the RAN node, as indicated by the timing measurements;
   most stationary of the candidate relay UEs; and
   powered by mains or highest remaining stored energy of the candidate relay UEs.
B4. A method for a positioning node associated with a radio access network (RAN), the method comprising:
   receiving, from a core network node (CNN) associated with the RAN, a request to determine a position of a remote UE that is present but out-of-coverage with respect to the RAN, wherein the request includes an identifier of a relay UE for communication between the remote UE and the RAN;
   obtaining, from the relay UE, first positioning measurements performed by the remote UE and second positioning measurements performed by the relay UE on a sidelink (SL) with the remote UE; and
   determining the position of the remote UE based on the first and second positioning measurements.
B5. The method of embodiment B4, further comprising sending the determined position of the remote UE to the CNN.
B6. The method of any of embodiments B4-B5, wherein the first positioning measurements include any of the following:
   timing measurements made by the remote UE on signals transmitted by the relay UE: and
   multipath received power measurements made by the remote UE on signals transmitted by the relay UE.
B7. The method of any of embodiments B4-B6, wherein the second positioning measurements include any of the following:
   timing measurements made by the relay UE on signals transmitted by the remote UE: multipath received power measurements made by the relay UE on signals transmitted by the remote UE.
   timing measurements made by the relay UE on signals transmitted by a RAN node:
   multipath received power measurements made by the relay UE on signals transmitted by a RAN node; and
   time-difference measurements made by the relay UE on signals transmitted by a plurality of RAN nodes.
B8. The method of any of embodiments B1-B7, wherein the positioning node is a location management function (LMF), and CNN is an access and mobility management function (AMF).
C1. A core network node (CNN) configured to support positioning of user equipment (UEs) in a radio access network (RAN), the CNN comprising:
   communication interface circuitry configured to communicate with a positioning node and with UEs via the RAN; and
   processing circuitry operatively coupled to the communication interface circuitry, whereby the processing circuitry and the communication interface circuitry are configured to perform operations corresponding to any of the methods of embodiments A1-A10.
C2. A core network node (CNN) configured to support positioning of user equipment (UEs) in a radio access network (RAN), the CNN being further configured to perform operations corresponding to any of the methods of embodiments A1-A10.
C3. A non-transitory, computer-readable medium storing computer-executable instructions that, when executed by processing circuitry of a core network node (CNN) configured to support positioning of user equipment (UEs) in a radio access network (RAN), configure the CNN to perform operations corresponding to any of the methods of embodiments A1-A10.
C4. A computer program product comprising computer-executable instructions that, when executed by processing circuitry of a core network node (CNN) configured to support positioning of user equipment (UEs) in a radio access network (RAN), configure the CNN to perform operations corresponding to any of the methods of embodiments A1-A10.
D1. A positioning node associated with a radio access network (RAN), the positioning node comprising:
   communication interface circuitry configured to communicate with a core network node and with user equipment (UE) via the RAN; and
   processing circuitry operatively coupled to the communication interface circuitry, whereby the processing circuitry and the communication interface circuitry are configured to perform operations corresponding to any of the methods of embodiments B1-B8.
D2. A positioning node associated with a radio access network (RAN), the positioning node being further configured to perform operations corresponding to any of the methods of embodiments B1-B8.
D3. A non-transitory, computer-readable medium storing computer-executable instructions that, when executed by processing circuitry of a positioning node associated with a radio access network (RAN), configure the positioning node to perform operations corresponding to any of the methods of embodiments B1-B8.
D4. A computer program product comprising computer-executable instructions that, when executed by processing circuitry of a positioning node associated with a radio access network (RAN), configure the positioning node to perform operations corresponding to any of the methods of embodiments B1-B8.

1. A method for a positioning node associated with a radio access network (RAN), the method comprising:
receiving, from a core network node (CNN) associated with the RAN, a request for a position of a target UE that is present but out-of-coverage with respect to the RAN, wherein the request includes an identifier of a reference UE for communication between the target UE and the RAN;
obtaining, from the reference UE, positioning measurements performed on a sidelink between the reference UE and the target UE;
determining the position of the target UE based on the obtained positioning measurements; and
sending the position of the target UE to the CNN, in accordance with the request.

2. The method of claim 1, wherein the obtained positioning measurements include first positioning measurements performed by the target UE and second positioning measurements performed by the reference UE.

3. The method of claim 2, wherein the first positioning measurements performed by the target UE include any of the following on signals transmitted by the reference UE: timing measurements, and power measurements.

4. The method of claim 2, wherein the second positioning measurements performed by the reference UE include any of the following:
timing measurements made by the reference UE on signals transmitted by the target UE;
power measurements made by the reference UE on signals transmitted by the target UE;
timing measurements made by the reference UE on signals transmitted by a RAN node;
power measurements made by the reference UE on signals transmitted by a RAN node; and
time-difference measurements made by the reference UE on signals transmitted by a plurality of RAN nodes.

5. The method of claim 1, further comprising:
receiving, from the CNN, a further request for a reference UE for communication between the target UE and the RAN;
obtaining further positioning measurements associated with a plurality of candidate reference UEs;
selecting a first one of the candidate reference UEs as the reference UE for the target UE, based on the further positioning measurements; and
sending to the CNN an identifier of the selected first candidate reference UE, in accordance with the further request.

6. The method of claim 5, wherein the further positioning measurements associated with each candidate reference UE include one or more of the following:
one or more of the following measurements made by the candidate reference UE of signals transmitted by a RAN node: received power, and timing;
one or more of the following measurements made by the RAN node of signals transmitted by the candidate reference UE: received power, and timing; and
a degree of stationarity of the candidate reference UE; and
energy conditions associated with the candidate reference UE.

7-8. (canceled)

9. The method of claim 5, where the identifier of the selected first candidate reference UE sent to the CNN is the identifier of a reference UE that is received from the CNN in the request for a position of the target UE.

10. The method of claim 1, wherein the positioning node is a location management function (LMF) and the CNN is an access and mobility management function (AMF).

11. A method for a core network node (CNN) configured to support positioning of user equipment (UEs) in a radio access network (RAN), the method comprising:
receiving, from a first positioning node, a first request for positioning of a target UE;
determining that the target UE is present but out-of-coverage with respect to the RAN;
sending, to a second positioning node, a second request for a position of the target UE, wherein the second request includes an identifier of a reference UE for communication between the target UE and the RAN;
receiving the position of the target UE from the second positioning node, in accordance with the second request; and
sending the position of the target UE to the first positioning node, in accordance with the first request.

12. The method of claim 11, wherein the CNN is associated with a database that includes a plurality of records associated with a respective plurality of UEs, each record including a last known location for a particular UE and a last known reference UE for the particular UE.

13. The method of claim 12, wherein:
determining that the target UE is present but out-of-coverage with respect to the RAN is based on one of the following by the target UE: a previous authentication, or a previous registration; and
the previous authentication or the previous registration was performed by the CNN according to one of the following: directly with the target UE, or indirectly with the target UE via the reference UE.

14. The method of claim 12, further comprising determining the reference UE for communication between the target UE and the RAN.

15. The method of claim 14, wherein determining the reference UE for communication between the target UE and the RAN comprises:
sending a page for the target UE to a last known reference UE for the target UE;
receiving, from the last known reference UE, a response indicating whether the target UE responded to the page;
selecting the last known reference UE as the reference UE based on the response indicating that the target UE responded to the page;
sending, to the second positioning node, a third request to identify a reference UE for communication between a target UE and the RAN; and
receiving, from the second positioning node, a third response including an identifier of a candidate reference UE selected by the second positioning node.

16. (canceled)

17. The method of claim 15, wherein the identifier of the candidate reference UE that is received from the second positioning node is the identifier of a reference UE that is sent to the second positioning node in the second request.

18. The method of claim 15, wherein sending the request to identify a reference UE to the second positioning node is based on one or more of the following:
the database record associated with the target UE does not include a last known reference UE; and
an indication that the target UE did not respond to a page via the last known reference UE.

19. The method of claim 11, further comprising storing the position of the target UE in the database record associated with the target UE.

20. The method of claim 11, wherein the first positioning node is a gateway mobile location center; the second positioning node is a location management function (LMF); and the CNN is an access and mobility management function (AMF).

21. The method of claim 11, further comprising:
in response to the first request, paging the target UE via the reference UE to determine a time required to position the target UE; and
sending, to the first positioning node, an indication of the time required to position the target UE.

22. The method of claim 21, wherein paging the target UE via the reference UE comprises:
sending to the RAN a paging message that includes an identifier of the target UE and a paging reason associated with locating the target UE; and
receiving from the RAN a paging response indicating when the target UE responded to a page from the RAN via the reference UE.

23. A positioning node associated with a radio access network (RAN), the positioning node comprising:
communication interface circuitry configured to communicate with a core network node and with user equipment (UE), via the RAN; and
processing circuitry operatively coupled to the communication interface circuitry, whereby the processing circuitry and the communication interface circuitry are configured to:
receive, from a core network node (CNN) associated with the RAN, a request for a position of a target UE that is present but out-of-coverage with respect to the RAN, wherein the request includes an identifier of a reference UE for communication between the target UE and the RAN:
obtain, from the reference UE, positioning measurements performed on a sidelink between the reference UE and the target UE;
determine the position of the target UE based on the obtained positioning measurements; and
send the position of the target UE to the CNN, in accordance with the request.

24-34. (canceled)
